(19) United States
(12) Patent Application Publication
(10) Pub. No.: US 2001/0026859 A1
(43) Pub. Date: Oct. 4, 2001

(54) Functional films, their use, articles having the films and processes for producing these

(76) Inventors: Toru Nakamura, Kawasaki-shi (JP); Akiko Miyakawa, Sagamihara-shi (JP); Masahito Suzuki, Kawasaki-shi (JP); Kazutoshi Oohashi, Tokyo (JP); Nobuyuki Nakagiri, Tsukuba-shi (JP); Ryoichi Fukasawa, Tochigi-ken (JP)

Correspondence Address: MORGAN, LEWIS & BOCKIUS, 1800 M STREET NW, WASHINGTON, DC, 20036-5869, US

(21) Appl. No.: 09/725,198

(22) Filed: Nov. 29, 2000

(30) Foreign Application Priority Data
Nov. 30, 1999 (JP) 11-339165
Feb. 17, 2000 (JP) 2000-045152
Mar. 17, 2000 (JP) 2000-075243
Mar. 21, 2000 (JP) 2000-078008
Mar. 22, 2000 (JP) 2000-079383

(51) Int. Cl. B32B 1/00

(52) U.S. Cl. 428/141

(57) ABSTRACT

A functional film at least one surface of which has at least one of characteristics that (1) the surface has an unevenness that its surface roughness is from 10 A to 500 A as RMS value; (2) the surface has an unevenness whose pitch has an average value not larger than the RMS value of surface roughness; and (3) the surface comprises an oxide of an inorganic element (represented by M), and the value of [number of carbon atoms]/[number of M atoms] at the surface is 0.1 or less; an article having such a film; and processes for producing these are provided in the present invention.

This application is based on Japanese Patent Applications No. 11-339165, No. 2000-45152, No. 2000-75243, No. 2000-78008 and No. 2000-79383 filed in Japan, the contents of which are incorporated hereinto by reference.

### BACKGROUND OF THE INVENTION

1. Field of the Invention

This invention relates to a functional film having functions such as anti-fogging properties, stain-proofing properties and anti-reflecting properties, an article such as an optical article or a construction material, having such a film on the surface, and processes for producing these.

2. Description of the Related Art

Adhesion of contaminants and water droplets comes into question in optical articles such as mirrors, lenses and prisms; construction materials such as window glass and outer-wall panels; and window glass and exterior trim parts for vehicles such as ships and automobiles.

Especially when minute water droplets adhere to articles required to have surface transparency as in optical articles and windowpanes, a haze or fog occurs to obstruct the transparency greatly.

Optical instruments making use of optical articles such as mirrors, lenses and prisms, eye-glass lenses, windows of buildings, windows or mirrors of automobiles, and mirrors installed in bathrooms or at washstands may become foggy with water vapor. Such a phenomenon of fogging is a phenomenon that occurs every day frequently. This fogging is caused when substrates come to have a surface temperature not higher than the due point, where the water in air in an atmosphere adheres to the surface in the form of minute water droplets, which cause light scattering.

Since this fogging is a phenomenon that occurs everywhere, many attempts have been made in order to prevent it. Such attempts may include, e.g., (a) a method in which the substrate surface is made water-repellent to prevent water from adhering, (b) a method in which the surface is heated to cause water droplets present thereon to evaporate, and (c) a method in which the substrate surface is made hydrophilic so that the whole surfaces of the substrate may wet with ease, to keep water droplets from occurring. Also, as materials having anti-fogging properties and mar-proofing properties, anti-fogging thin films are known which can be obtained by forming an inorganic oxide such as silicon oxide into a film by the sol-gel process.

However, in the method (a), in which the surface is made water-repellent, it has not been accomplished under existing circumstances to materialize a water-repellency good enough to perfectly prevent water from adhering, and hence such a method is not practical. In general, to surfaces having been treated to become water-repellent, spherical water droplets may adhere to tend to fog on the contrary in many cases.

The method (b), in which the surface is heated to cause water droplets to evaporate, has been put into practical use in, e.g., rear windows of automobiles. This method, however, restricts applicable objects to articles that can be heated, and also requires a heating mechanism such as a power source and heating wires. Thus, this method can not be general-purpose. Especially in the case of automobile windshields, glass lenses and so forth for which a perfect transparency is required, this method is applicable with difficulty because it requires heating wires that obstruct the transparency.

Accordingly, the method (c), in which the surface is made hydrophilic, is employed in many cases. Of this method, the most simple method is applying a surface-active agent to the substrate surface. This has been put into practical use as a anti-fog glass spray. It is also attempted to endow the surface with hydrophilic properties by forming a film of a hydrophilic polymer on the substrate surface.

Incidentally, in the method making use of the anti-fog spray is used, it is difficult to apply the surface-active agent uniformly, and there has been a problem that the surface may undergo a deterioration of optical characteristics. Also, there is another problem that the surface-active agent applied tends to become removed and its effect can not be maintained unless it is repeatedly applied each time.

In the fields of construction and coating, contamination of construction exterior materials and outdoor building structures as well as coating films provided thereon has also come into question with occurrence of environmental pollution. Outside the fields of construction and coating, too, as in optical component parts such as mirrors and lenses, inner walls of analyzers used in elementary analysis or the like, and containers for keeping specimens therefor, there is an increasing demand for providing stain-proofing properties.

Soot and particles floating in the atmosphere deposit on roofs and outer walls of buildings during fine weather. Deposits are washed way by rain water with rainfall and flow down the outer walls of buildings. During rainfall, floating soot is further carried by rain and flows down the outer walls of buildings and the surfaces of outdoor building structures. As the result, contaminants come to adhere to outer-wall surfaces of buildings along their courses of rain water. Then, once the surfaces of outer walls thus contaminated have dried, stripe-like stains appear on their surfaces.

Stains on building exterior materials and on coating films are composed of combustion products such as fine carbon particles in many cases. In a conventional common idea, in order to prevent building exteriors from staining, it has been considered preferable to apply water-repellent coating materials such as polytetrafluoroethylene (PTFE). Recently, however, against city soot containing lipophilic components in a large quantity, it is considered desirable to make coating film surfaces hydrophilic as far as possible.

Accordingly, at present, in order to materialize anti-fogging properties and/or stain-proofing properties, various hydrophilic coating materials are commercially available as exemplified by acrylic polymers, acrylic silicone polymers, water-based silicones, block copolymers of silicone polymers with acrylic polymers, acrylic styrene polymers, sorbitan fatty acid ethylene oxides, sorbitan fatty acid esters, urethane type acetates, cross-linked urethanes of polycarbonate diols or polyisocyanates, and polyacrylic acid-acrylate cross-linked products.

However, even when these hydrophilic coating materials are used, it has not been able to effectively prevent the staining due to the city soot containing lipophilic components in a large quantity. Also, in the case of optical component parts and analyzers, it is impossible to use any coating materials containing volatile components as being different from construction materials, and it has been very difficult to endow the surface with stain-proofing properties.

In the case when hydrophilic polymeric films are formed on substrate surfaces by coating such hydrophilic coating materials, film surfaces may have an insufficient hardness to have low mar-proofing properties. In addition to such a problem, there has been a problem that films may be formed so non-uniformly and in so large a thickness that any good optical characteristics can not be expected.

In addition to these problems, as problems common to all functional films, there have been problems concerning how long the anti-fogging properties and anti-staining properties can be maintained. Those having good anti-fogging properties at the initial stage where films have been formed are conventionally already available in a large number. Unfortunately, however, under actual circumstances, there is practically no functional film whose effect can surely be maintained and which is serviceable over a long period of time.

Moreover, where optical lenses making use of conventional anti-fogging and anti-staining thin films are superposed, there has been a problem that a low light transmittance may result to adversely affect optical characteristics of optical members.

One may also contemplate enhancing surface hydrophilic properties by the oxidative effect of titanium oxide, i.e., what is called a photocatalytic effect. This method, however, leaves a problem in respect of the prevention of reflection, because of the property of high refractive index that is inherent in titanium oxide. In addition, in order to make titanium oxide exhibit its photocatalytic effect, it is necessary to irradiate the titanium oxide with ultraviolet radiations for a long time, taking labor and time to impart anti-fogging properties and stain-proofing properties. Also, in the case when the photocatalytic effect is utilized, the hydrophilic properties having once come out may gradually become weak in its effect when left in the dark, and the hydrophilic properties can not be maintained unless the titanium oxide is periodically irradiated by light. Hence, this has not been effective when the anti-fogging properties and stain-proofing properties should be maintained over a long period of time.

Furthermore, in the case when construction materials such as window glass and outer-wall panels are coated with stain-proofing coating materials, which are coating materials provided with stain-proofing properties, the coating materials may have an insufficient adhesion or wettability depending on the quality of the construction materials, and it has been difficult in many cases to endow them with stain-proofing properties durable for practical use.

Where the stain-proofing properties have lowered, coating materials must be applied anew. In addition thereto, in an attempt to apply stain-proofing coating materials after a building has been constructed, they can be applied with difficulty in many cases because of spatial restriction and environmental restriction. Moreover, in conventional methods, it has been very difficult to form functional films having anti-fogging properties and stain-proofing properties, depending on the shape and size of applicable objects.

### SUMMARY OF THE INVENTION

In order to enhance hydrophilic properties of article surfaces to endow them with anti-fogging properties and stain-proofing properties, one may contemplate forming on the outermost layer of a transparent material a film comprised of an organic compound having a hydrophilic functional group, such as a surface-active agent, hydroxyethyl methacrylate, polyether or polyvinyl alcohol. As a method of forming this film, the film may be formed by coating or spraying any of these organic compounds on the substrate surface.

A method may also be used in which, using a material comprised of combination of a hydrophilic vinyl compound and an organosilane compound, this material is coated on the substrate surface. Alternatively, a surface-active agent may previously be added to and kneaded in an uncured polymeric precursor composition and thereafter the resultant kneaded product may be molded to produce an article.

The present inventors used the organic compound having a hydrophilic functional group, such as the surface-active agent hydroxyethyl methacrylate, polyether or polyvinyl alcohol, and applied these compounds on a plastic substrate by dipping or brushing to form a thin functional film. They also sprayed such an organic compound on a plastic substrate by means of a sprayer to form a thin functional film.

As a result of examination of durability of the functional films thus formed, the anti-fogging and stain-proofing effect was not maintainable for a long term and any films having a satisfactory durability were obtainable. Also, where the functional film was formed using the conventional material and film-forming method after a reflection preventive film was formed on the substrate, the reflection preventive effect was adversely affected in some cases.

Accordingly, the present inventors changed the material for the material comprised of combination of a hydrophilic vinyl compound and an organosilane compound to form a functional film. In order to attempt to improve its durability, this material was coated on the surface of a plastic substrate by coating to form an anti-fogging thin film. However, any improvement in durability of the anti-fogging thin film was not achievable.

The present inventors also attempted to endow a plastic substrate with anti-fogging properties and stain-proofing properties; the substrate being molded by the method in which a surface-active agent is added to and kneaded in an uncured polymeric precursor composition and thereafter the resultant kneaded product is molded. However, even this method did not enable any improvement in durability of the anti-fogging thin film. In particular, this method had limitations on the combination of usable plastic materials and surface-active agent, lacking in general-purpose properties, and also had limitations on the quantity in which the surface-active agent can be kneaded in, thus this method was not practical and was a method having a poor efficiency.

Accordingly, an object of the present invention is to provide a functional film that can maintain sufficient anti-fogging properties and stain-proofing properties for a long term and can be so practically useful as not to adversely affect reflection preventive performance and so forth. As a result of repeated extensive studies, the present inventors have discovered that good anti-fogging and stain-proofing effect can be achieved and superior anti-fogging and stain-proofing effect can be maintained over a long period of time without adversely affecting reflection preventive performance, when a fine uneven (or hill-and-dale) structure is formed at the film surface. Thus they have accomplished the present invention.

What is meant by the “fine uneven structure at the film surface” is that;

(1) the film surface has a roughness of from 10 A to 500 A as RMS value; or

(2) the film surface has an unevenness whose pitch has an average value not larger than the RMS value of surface roughness.

According to the present invention, the functional film is also a film formed of an oxide of an inorganic element (represented by M) so that high stain-proofing properties can be achieved. This can provide a very clean surface such that the value of [number of carbon atoms]/[number of M atoms] at the surface is 0.1 or less. The present inventors have discovered that such a clean surface can contribute to the achievement of high anti-fogging properties and stain-proofing properties. Controlling in this way the ratio of the amount of metal atoms to the amount of carbon constituting organic contaminants present on the surface enables improvement of stain-proofing properties.

Thus, in order to solve the problems discussed previously and achieve long-term maintainable good anti-fogging properties and stain-proofing properties, the present invention provides a functional film at least one surface of which has at least one of the following characteristics (1) to (3). The film may have at least one of these characteristics (1) to (3), and may preferably have at least two of these.

(1) The surface has an unevenness that its surface roughness is from 10 A to 500 A (and preferably from 20 A to 100 A) as RMS value;

(2) the surface has an unevenness whose pitch has an average value not larger than the RMS value of surface roughness; and

(3) the surface comprises an oxide of an inorganic element (represented by M), and the value of [number of carbon atoms]/[number of M atoms] at the surface is 0.1 or less.

The functional film of the present invention may be at least one of an anti-fogging film, a stain-proofing film and a reflection preventive film. Especially when the surface has hydroxyl groups, good anti-fogging properties and stain-proofing properties can be achieved. Also, the surface may preferably have a reflectance of 3% or smaller (and preferably 0.1% or larger) to light with a wavelength of 450 to 800 nm. This brings about an improvement in light transmittance of the functional film, so that not only the anti-fogging properties and stain-proofing properties but also optical performance can be improved. Thus, such a film is suited especially when used in optical articles.

In the functional film of the present invention, the pitch of the unevenness provided at the surface may preferably have an average value of from 1 A to 1,000 A. The functional film of the present invention should have a thickness of from 200 A or larger (preferably 500 A or larger), and more preferably 1,200 A or smaller.

The functional film of the present invention may contain any of an inorganic oxide and an organic macromoleculae (e.g. polymer). In the case of an inorganic oxide film, it may preferably contain a silicon oxide. Also, where the film contains hydrophilic particles, the hydrophilic particles can stand bare to the surface to form fine unevenness and also more improve the surface hydrophilic properties, thus such a film is preferred.

The present invention also provides a method of use of a functional film in which the functional film of the present invention is used to prevent at least one of fogging due to water droplets and adhesion of contaminants, and provides an article such as an optical article or a sheet, having at its surface the functional film of the present invention. The sheet of the present invention has a sheetlike substrate and the functional film described above, provided on one-side surface of the both sides of the substrate. In the case of such a sheet, the sheetlike substrate may be provided with an adhesive film on the other-side surface. This is preferred because the sheet can readily be stuck on any desired place. In the present invention, the anti-fogging and stain-proofing properties and the period during which they can be maintained depends on the unevenness present at the outermost surface. In order to endow the surface with anti-fogging and stain-proofing properties without dependence on the size and shape of an article, not a stain-proofing coating film or thin film is directly formed on an article as conventionally done, but a separate member (such as a sheet) may previously be endowed with anti-fogging and stain-proofing properties and such a member may be put (e.g., stuck) onto an article to be endowed with the anti-fogging and stain-proofing properties.

The present invention still also provides a sheet comprising a substrate formed of an organic high polymer and a film having stain-proofing properties, provided on the surface of the substrate. In this sheet, the film may preferably contain a silicon oxide.

The functional film of the present invention may preferably be formed by a dry process, and particularly preferably be formed by sputtering because the fine unevenness can be formed with ease. Accordingly, the present invention provides a process for producing a functional film or an article, comprising the step of forming a functional film by a dry process (in particular, sputtering).

Formation of the functional film by sputtering is carried out through a film-forming step of forming by sputtering a film having anti-fogging and stain-proofing properties, on a substrate. This film-forming step comprises the steps of, e.g., placing the substrate in a vacuum chamber and placing a target composed chiefly of an inorganic oxide, at a position facing the substrate; setting the internal pressure of the vacuum chamber to from 1 Pa to 10 Pa; feeding a sputtering gas into the vacuum chamber; and applying a voltage to the target. Incidentally, in the step of applying a voltage to the target, the substrate temperature may preferably be set not higher than 150° C. and not lower than 30° C. Also, the sputtering gas may preferably be an inert gas containing no oxygen.

In the case of the functional film formed of an organic high polymer, a polymeric composition or polymeric precursor composition containing hydrophilic particles may be formed into a film, followed by curing to form a functional film containing the hydrophilic particles. The functional film may also be produced by a process comprising the steps of forming into a film a polymeric composition or polymeric precursor composition containing hydrophilic particles, removing the particles, and curing the film of the polymeric composition or polymeric precursor composition. This process is suited for the present invention because voids produced as a result of removal of the particles constitute the fine unevenness of the film surface. Incidentally, either the removal of particles or the curing of the composition may be carried out first or the both may be done simultaneously, as occasion calls.

### BRIEF DESCRIPTION OF THE DRAWINGS

FIG. 1 is an electron microscope photograph showing a cross-sectional structure of an article having the functional film in Example 1.

FIG. 2 is a schematic cross-sectional view showing a stacked material prepared in Example 3.

FIG. 3 is a wide-scan spectrum of a functional film of Example 5, surface-analyzed by X-ray photoelectron spectroscopy. Peak 1 is a peak of photoelectrons due to silicon; and peak 2 is a peak of photoelectrons due to carbon.

FIG. 4 is a schematic cross-sectional view of a stain-proofing sheet of Example 8.

### DETAILED DESCRIPTION OF THE INVENTION

In the present invention, the anti-fogging properties and stain-proofing properties are achieved by endowing a film with hydrophilic properties, i.e., the characteristic of providing a small contact angle of water at rest. In the case of a hydrophilic film, the water spreads wettingly over the whole thin-film surface, without adhering to the film surface in the form of water droplets. This makes light scattering not occur, so that fogging can be prevented from occurring and also any contaminants can be kept from adhering.

In the case when the surface is provided with hydrophilic properties by conventional anti-fogging spraying, it shows hydrophilic properties immediately after it has been provided with hydrophilic properties. In usual cases, however, its effect does not last long, the contact angle of water comes to be 30 degrees or larger only in one day to few days, and the surface may fog when breathed on. In the functional film of the present invention, however, hydrophilic properties as high as those immediately after film formation can be maintained over several months or more. In the past, when hydrophilic properties, anti-fogging properties and stain-proofing properties are discussed, only values of contact angles measured at certain points of time have been discussed in many cases. From a practical point of view, however, it is considered rather appropriate to regard changes with time of anti-fogging properties as an index of evaluation.

Accordingly, in the present invention, in the evaluation of anti-fogging properties, not only contact angles of water immediately after formation of the functional film but also contact angles of water upon lapse of a certain period after the film formation are measured, and these measurements are compared to evaluate the maintenance of the properties. Incidentally, hydrophilic properties necessary for films to exhibit their anti-fogging properties may differ depending on, e.g., conditions under which the films are used, but in general it can be said that the films have anti-fogging performance as long as the contact angle of water is 20 degrees or smaller. When the contact angle of water is 5 degrees or smaller, the films can be evaluated as having very good hydrophilic properties and anti-fogging properties. Accordingly, in the present invention, this is used as a criterion of the evaluation of anti-fogging properties.

In the present invention, the surface roughness of the film is expressed as a value of root mean square (RMS), RMS value, of the amount of change of hills and dales on a profile of roughness. When the film is formed to have a surface the RMS value of which is from 10 A to 500 A, superior anti-fogging properties and stain-proofing properties can be maintained over a long period of time. When the film surface has an RMS value of from 20 A to 100 A, particularly excellent effects can be obtained.

This RMS value shows a depth of dales of the surface, and does not show the number of the dales. Hence, a film having a large RMS value can also be said to be a film having deep dales. Incidentally, the surface roughness is measured with an atomic force microscope (AFM).

In the present invention, it is preferable for the surface (preferably the whole surface) of the functional film to be covered with an unevenness (hilts and dales) having such a specific depth. Also, the distance between hills of this unevenness (i.e., pitch of unevenness) may preferably be from about 1 A to about 1,000 A as an average value.

In the present invention, the average value of the pitch of surface unevenness may preferably be not larger than the RMS value of surface roughness (i.e., [average value of pitch of unevenness]/[RMS value of surface roughness of unevenness]≦1). This means that a surface with a deeper unevenness is preferred and a surface with a finer pitch of unevenness is preferred.

The average value of the pitch of unevenness can be found by arbitrarily picking up a group of 10 hills and averaging the distances between them. Here, a group of more than 10 hills may be picked up to average the distances between them to find the average value of the pitch of unevenness.

The reason why the film where such a fine unevenness has been formed maintains superior anti-fogging properties and stain-proofing properties are not necessarily clear. It is presumed that the anti-fogging properties are maintained because the dales providing the RMS value of the present invention are in a depth suited for water to be retained therein over a long period of time. Hence, the functional film of the present invention can be used as an anti-fogging film.

The functional film of the present invention also has high hydrophilic properties, and hence it is presumed that the water in air adheres to the surface and this water having adhered thereto prevents any hydrophobic stains such as oils from adhering. On account of this stain-proofing effect, the functional film of the present invention can be used also as a stain-proofing film.

The present invention further provides a functional film having a film surface comprising an oxide of an inorganic element (represented by M), and the value of [number of carbon atoms]/[number of inorganic element M atoms] at the surface as measured by X-ray photoelectron spectroscopy is 0.1 or less.

In the case of usual inorganic oxide films, the value of [number of carbon atoms]/[number of M atoms] may rise soon even when it is small immediately after the film has been formed. This indicates that the surface which is clean immediately after film formation becomes contaminated because of immediate adhesion of organic contaminants containing carbon. The carbon is a chief element that constitutes the organic contaminants, and it means that, the smaller the quantity of carbon detected is, the less the surface is contaminated.

The X-ray photoelectron spectroscopy is an analytical method in which the surface of a sample is irradiated with X-rays to detect electrons (photoelectrons) thereby emitted. From energy of the photoelectrons detected, elements having emitted the photoelectrons are specified to make qualitative analysis. From the quantity of the photoelectrons detected, it is also possible to further make quantitative analysis of the elements having emitted the photoelectrons.

The depth of escape of photoelectrons may differ depending on angles of X-ray irradiation and on elements with which the surface is irradiated. Approximately, it is from several A to tens of A. Hence, only surface information of the sample to be analyzed can be detected, and this method can be said to be an advantageous method for surface analysis.

The functional film of the present invention is a film wherein the value of [number of carbon atoms]/[number of M atoms] (where the inorganic oxide is represented by MₓO_{y}. Letter symbols x and y each represent an arbitrary natural number) is 0.1 or less, and can maintain its stain-proofing effect for a month or longer after film formation. This means that the state of clean surface immediately after film formation lasts for a month or longer.

The functional film of the present invention can be formed by a dry process such as sputtering, vacuum deposition or CVD (chemical vapor deposition) or by a wet process such as a sol-gel process, without any particular limitations. The functional film of the present invention may be produced by a process including, but not particularly limited to, the wet process and the dry process. Any suitable processes may be employed, and it is preferable to form the film by sputtering. In the case of the sputtering, the internal pressure of a vacuum chamber at the time of sputtering may be set a little higher to carry out film formation, whereby the stain-proofing oxide film of the present invention can be obtained. Also, in the case when the wet process is employed, the concentration of a solution used, treatment time, temperature and so forth may be regulated, whereby the desired unevenness can be formed at the surface of the functional film. Also, in the case when the sol-gel process is employed, the surface unevenness can be formed also by using a liquid containing fine particles and forming it into a film.

To form the unevenness at the functional-film surface, various methods may be employed, such as a method in which, in sputtering or vacuum deposition, conditions for film formation such as the setting of internal pressure of a vacuum chamber, substrate position, substrate temperature and rate of film formation are controlled, and a method in which films having been formed are treated by etching (e.g., treated with plasma or immersed in an acid solution or an alkali solution).

In the case when an inorganic oxide is formed into films by sputtering, it is preferable to use a target composed chiefly of an oxide and feed into a vacuum chamber an oxygen-free inert gas as a sputtering gas. Inert gases usable in the present invention are argon, krypton and so forth, without any particular limitations. Sputtering systems are grouped into DC (direct-current) sputtering and RF (radio frequency) sputtering. In the present invention, RF sputtering may preferably be used.

In the case when an inorganic oxide is formed into films by sputtering to form the functional film of the present invention, setting the internal pressure of a vacuum chamber relatively a little higher makes it possible to obtain inorganic oxide thin films having superior anti-fogging properties. Stated specifically, the internal pressure may preferably be set at from 1 Pa to 10 Pa. This is because setting the pressure a little higher enables sputter particles to reach the substrate at a low energy and makes it easy to form a thin film having a rough surface, e.g., having a columnar structure (as viewed cross-sectionally).

As for the substrate temperature at the time of sputtering, a lower temperature is preferred. It may preferably be set not higher than 150° C. and not lower than 30° C. (i.e., from 30° C. to 150° C.). This is because at a low temperature the sputter particles may migrate on, or react with, the substrate surface with difficulty to make it easy to form the thin film having a rough surface, e.g., having a columnar structure.

The functional film of the present invention may preferably have the columnar structure in its vertical sectional structure. The present inventors presume that the film having such a columnar structure allows water to adhere to its surface in a large quantity, to enhance the effect of wetting-spread of water having adhered and the effect of preventing adhesion of organic contaminants. To form such a columnar structure, when formed by sputtering, the internal pressure of a vacuum chamber at the time of film formation may be set relatively a little higher (e.g., at 1 Pa or higher and 10 Pa or lower), or RF power may be set a little higher than that set when usual oxide films (such as a reflection preventive film) are formed. This is because setting the pressure a little higher enables sputter particles to reach the substrate at a low energy and makes it easy to form the thin film having a rough surface, e.g., having a columnar structure. Also, the surface of a substrate on which the functional film is to be formed may previously be treated with plasma or treated with an alkali to roughen the surface beforehand. This is also effective to form the columnar structure.

The functional film of the present invention may directly be formed on the substrate, or may be formed on a coating layer that covers the substrate. In the latter case, the characteristics and layer thickness of the functional film of the present invention and those of the coating layer other than the film of the present invention may be controlled so that the coating layer can further be endowed with superior characteristics in addition to the anti-fogging and stain-proofing effect. Especially when the functional film of the present invention is formed by the dry process, it becomes possible to make precise layer thickness control, and hence an effect as an optical thin film can be imparted. For example, a reflection preventive effect can be imparted. In this case, the uppermost layer of a multi-layer reflection preventive film may be formed as the functional film. This enables formation of a reflection preventive film having anti-fogging properties and stain-proofing properties. Incidentally, in the case when the functional film of the present invention is utilized as the reflection preventive film, the functional film may preferably be formed in a layer thickness of 1,200 A or smaller, and more preferably 1,000 A or smaller.

As materials for such an underlying layer having a reflection preventive function, besides the inorganic oxide, magnesium fluoride or the like may be used in view of its characteristics, having a low refractive index. In particular, two types of materials such as silicon oxide/titanium oxide or silicon oxide/zirconium oxide may alternately be superposed in the whole multi-layer film including the functional film. Such construction can make designing and manufacture easy.

Where at least one layer of thin film is formed as the underlying layer of the functional film, this underlying thin film may preferably be formed by vacuum deposition or sputtering. Also, in the underlying base on which the functional film is to be formed, an unevenness may previously be formed, and the functional film may be formed thereon. Even in such a case, an unevenness can be formed at the surface of the functional film. Still also, a film containing hydrophilic particles may be formed to materialize a fine unevenness, or a film containing removable particles may be formed and then the particles may be removed therefrom to provide a fine unevenness. Thus, the thin-film surface unevenness may be formed simultaneously at the time of film formation, or treatment for forming the unevenness may separately be made after the film formation is completed.

There are no particular limitations on materials for constituting the functional film of the present invention. In the outermost surface, a material having hydrophilic groups is preferred. In the case when an inorganic oxide is used as a material for the functional film, a large number of hydrophilic groups such as silanol groups are present at the surface. Accordingly, an inorganic oxide such as silicon oxide, titanium oxide, zirconium oxide, zinc oxide, tantalum oxide, tungsten oxide, aluminum oxide or tin oxide may be used to thereby form a film having hydroxyl groups at the surface. This is preferred because high mar-proofing properties can be attained. Incidentally, also usable is an inorganic oxide film formed using a metal alkoxide as a material.

In particular, silicon oxide is suited to the present invention because especially good optical performance and mechanical performance can be attained and also the anti-fogging properties and stain-proofing properties can be maintained for a long term. In the case when the silicon oxide is used, the effect of controlling reflection of light from the surface can also be provided because the silicon oxide has a relatively low refractive index of about 1.5.

In the case of conventional stain-proofing films making use of a titanium oxide photocatalyst, it has been unable to control any strong surface reflection which occurs because of a high refractive index of the titanium oxide. However, the functional film formed of silicon oxide can fairly keep light from reflecting, and hence is preferably usable even when Windowpanes or mirrors required to have transparency are to be endowed with anti-fogging and stain-proofing properties.

Any of these inorganic oxides may be used alone or may be used in combination with a plurality of inorganic oxides. The inorganic oxide may also be constituted of a titanium-silicon mixed oxide, a zirconium-silicon mixed oxide, an aluminum-silicon mixed oxide or the like.

The functional film according to the present invention, which may preferably be the one having hydrophilic groups at the outermost surface, need not be formed of the inorganic oxide described above and may be formed using an organic compound having hydrophilic groups. Such an organic compound usable in the present invention may include, e.g., high molecular compounds such as polyacrylic acid, polyvinyl alcohol and polyvinyl pyrrolidone. Also usable are compounds having an ethyleneoxy group in the molecule.

The functional film of the present invention may preferably have a layer thickness of 200 A or larger (preferably 500 A or larger) in order to make the surface roughness large and improve the anti-fogging and stain-proofing effect. The present inventors have discovered that the film surface has a small roughness where the film deposited on a substrate is in the state of a small thickness and the film surface roughness increases with an increase in thickness of the film deposited, that is, the maintenance of anti-fogging properties and stain-proofing properties depends on the surface roughness (RMS value) of the anti-fogging thin film and the RMS value increases with an increase in layer thickness of the anti-fogging thin film. They actually formed functional films and measured their layer thickness and RMS value of the surface to find that a functional film with a layer thickness of 1,000 A was in an RMS value of 10 A, whereas one formed under the same conditions in a layer thickness of 5,000 A was in an RMS value of 25 A. Thus, taking account of maintaining the effect, the functional film of the present invention may preferably be formed in a thickness as large as possible. The present inventors consider that films having a layer thickness of 200 A or larger come to have a surface roughness large enough for water to adhere in a quantity necessary for the film surface to have a sufficient anti-fogging and stain-proofing effect.

Incidentally, it has been found that substantially the same effect as in the state where the functional film is formed in a large thickness can be obtained also when the functional film is so formed on a thin film formed of a different material, as to be in multi-layer (e.g., the uppermost layer of a multi-layer reflection preventive film is formed as the functional film) and the uppermost layer functional film is formed in a small thickness. For example, where a functional film with a layer thickness of 1,000 A is formed as the uppermost layer of the multi-layer reflection preventive film, its surface has an RMS value of nearly 25 A, and substantially the same anti-fogging properties and stain-proofing properties as those of the film with a layer thickness of 5,000 A can be maintained.

In the case when the functional film is formed in a small thickness, e.g., when it is formed in a layer thickness as small as about 1,000 A, the layer thickness and refractive index of each layer in the multi-layer film underlying as a base of the anti-fogging thin film may be controlled so that it can be formed as a reflection preventive film. Such a reflection preventive film has also anti-fogging properties and stain-proofing properties in addition to reflection preventive effect, and hence such a film is very suited for optical articles used at positions laid bare to the outside. Incidentally, when reflection preventive effect is taken into account, the film may preferably be formed in a layer thickness not larger than 1,200 A.

In the case when the functional film of the present invention is used as an anti-fogging film, it may preferably be formed in a layer thickness of from 200 A to 100 μm, and more preferably from 200 A to 10 μm. If it is in a layer thickness smaller than about 200 A, its anti-fogging performance can be maintained only for a short period in some cases.

The present invention provides an article having the functional film of the present invention. There are no particular limitations on the substrate on which the functional film is to be formed. It may be any substrate, including glass of various types, organic high polymers, silicon wafers, metals, ceramics, and laminates of these. As substrates comprised of organic high polymers, usable are, e.g., those obtained by molding and curing heat-curable or photo-curable monomers. Thus, various substrates are usable, and hence the present invention is applicable to various uses. Such various applicable objects may include, e.g., optical component parts such as lenses, mirrors and prisms; general-purpose mirrors such as rearview mirrors for vehicles, mirrors for bathrooms or washrooms, and mirrors for roads; window glass for construction; windshield glass for vehicles such as automobiles, motorcycles and ships; goggles, masks and helmet shields for protection or sporting uses; construction materials such as construction outer wall materials and interior materials; and daily necessities such as lighting fixtures and cookware.

Articles having the functional film of the present invention and being formed in sheets, i.e., those comprising a sheetlike substrate (e.g., a sheet or film of an organic macromolecule) and a functional film formed thereon may be divided in suitable size and shape and may be stuck on the surfaces of objects to be endowed with anti-fogging and stain-proofing properties. Thus, any members having a size that may make it difficult to form the functional film directly by sputtering or members having a shape that may make it difficult to form the film by sputtering, too, can be endowed with anti-fogging and stain-proofing properties with ease. Also, in the case of sheetlike (filmlike) articles, they can freely be bent, and hence the surfaces of construction materials or the like having complicate surface shapes such as free curved surfaces, too, can be endowed with stain-proofing properties.

When used for such purposes, such a sheet of the present invention may preferably have self-supporting properties, but need not necessarily have self-supporting properties. For example, the functional film may be formed on a support film and this may be stuck on applicable objects so that the support film may be peeled or removed thereafter, thus it can be stuck even without self-supporting properties.

There are no particular limitations on materials for substrates which may be used in the sheet of the present invention. For example, usable are a wide range of materials such as cellulose (e.g., cellophane), cellulose acetate, polyethylene, polypropylene, polyvinyl chloride, polystyrene, polyethylene terephthalate, polycarbonate, nylon 6, polyimide, polyvinylidene chloride, polyvinyl alcohol, fluorine resin, and rubber hydrochloride.

An adhesive may previously be applied to the surface of the substrate on its side opposite to the surface on which the functional film has been formed. This is preferable because the sheet can very easily be stuck. Also, as the substrate, a transparent material may be used so that the sheet can be applied also to articles required to have transparency, such as windowpanes and mirrors, or articles making much more of the beauty, such as daily necessities, without damaging the transparency and the beauty.

There are no particular limitations on methods by which the functional film of the present invention is formed on the surface of such a sheetlike or filmlike substrate of an organic high polymer. In order to enable always stable film formation without regard to the types of the substrate, sputtering may particularly preferably be used. Use of sputtering enables film formation at a temperature as low as 80° C. or below, or 50° C. or below depending on conditions. Hence, the functional film can be formed without care, also on plastic films or sheets having a low resistance to heat.

The functional film may be provided on one side of a substrate, or may be provided on both sides thereof. It may be provided on the whole surface, or may be provided on some part of the surface. In the case when the functional film is provided on one-side surface of the both sides of a sheetlike substrate or other substrate, a different film such as a reflection preventive film, a hard coat or an adhesive film may optionally appropriately be formed on the other-side surface.

The functional film of the present invention is also required to be formed on the outermost surface of an article. Between the substrate and the functional film, an additional layer may be provided so as to be multi-layered. For example, a hard coat may be provided to improve mar-proofing properties, or a layer formed of a material having a high refractive index may be provided to make the film have reflection preventive properties, or a cushioning layer may be provided to improve impact resistance.

According to the present invention, the anti-fogging properties and stain-proofing properties can be maintained over a longer period of time than conventional ones. Where the material having hydrophilic groups is used in the functional film, the effect can be more improved. Also, in the present invention, materials for the film are not particularly limited. Hence, where the functional film is formed using an inorganic compound having a high hardness, it can have superior mar-proofing properties and durability, so that, in addition to the effect of maintaining high anti-fogging properties and stain-proofing properties for a long term, functional films and articles having also a high durability can be obtained. Where the film is formed by the dry process such as vacuum deposition, a film also having a good adhesion can be obtained, and the film can be formed on glass, plastic and so forth without regard to the types of the substrate.

The articles having the functional film of the present invention can also enjoy a longer product life because of the high anti-fogging properties and stain-proofing properties that are maintainable for a long term, so that products having superior anti-fogging properties can be used over a long period of time. Also, those having the anti-fogging thin film formed of an inorganic oxide exhibit a high durability and hence can be used in various environments. Thus, the present invention can broaden the range over which the products having anti-fogging properties and stain-proofing properties are usable. Hence, the functional film of the present invention is widely applicable not only to the prevention of various optical instruments such as eye-glasses, cameras, microscopes, telescopes and binoculars from fogging and staining, but also to the prevention of windows of automobiles and so forth and bathroom mirrors from fogging and prevention of building inner and outer walls from staining.

The functional film of the present invention also has a surface of very little contaminants compared with any conventional stain-proofing films (e.g., those formed by coating a coating material), and hence it can be used for purposes where surfaces must always be kept from staining. For example, it may be used in optical component parts of optical systems of semiconductor fabrication apparatus so that the transmittance of optical systems can be prevented from lowering because of the staining of surfaces of optical component parts.

It can also prevent analyzing chamber inner walls from staining in analyzers (e.g., elementary analyzers). It can be used also on inner walls of containers for holding, e.g., semiconductor-related component parts or samples for analysis.

Recently, in observation with fluorescence microscopes, there is a problem that, since not only fluorescent light is emitted from samples to be observed but also unwanted fluorescent light is emitted from contaminants having adhered to optical systems of microscopes, the latter makes samples observable with difficulty. The functional film of the present invention may be formed as coatings on the optical systems of fluorescence microscopes, thus their surfaces can be prevented from staining, and such a problem can be solved.

Any contaminants having adhered to the surface of the functional film of the present invention can be removed with ease, and hence the film is suitable as a stain-proofing film for members placed in environments where they are frequently contaminated. Moreover, the functional film of the present invention, when used alone or in combination with any other coating layer, can provide not only the anti-fogging and stain-proofing effect but also, e.g., the reflection preventive effect. Such a functional film of the present invention can be applied also to fields having hitherto been unable to be endowed with anti-fogging and stain-proofing properties, e.g., optical component parts. Thus, according to the present invention, uses of functional films having anti-fogging and stain-proofing effect can be more broadened than ever.

In addition, the use of the sheet of the present invention, when used by sticking it on outer-wall panels, floors and ceiling panels of buildings or on windowpanes or mirrors made of glass or plastic, enables prevention of their surface contamination over a long period of time. Also, in addition to such use for buildings, the anti-fogging and stain-proofing sheet of the present invention can be used for various purposes. For example, it may be stuck on windows or bodies of vehicles such as automobiles to prevent them from fogging and staining. Also, a transparent sheet may be used and may be stuck on the surfaces of TV (television) monitors to prevent cathode ray tubes from staining. Still also, it may be stuck on the surfaces of clothes poles to prevent washings from being contaminated.

In addition to such daily common uses, the sheet of the present invention can also be used in specific industrial fields. For example, it can be used to prevent surface contamination in semiconductor fabrication steps where surfaces must be severely kept from contamination, or surface contamination of machinery and sample cases in microanalysis.

Thus, the sheet of the present invention may be cut out in any desired size and may be stuck on applicable objects, whereby their surfaces can be prevented from fogging and staining without dependence on the shape and size of the applicable objects.

In the sheet of the present invention, the functional film that can maintain the anti-fogging and stain-proofing properties over a long period of time is formed on the sheetlike substrate such as a plastic sheet or a plastic film, and hence the sheet may be stuck on object articles to endow their desired portions with anti-fogging and stain-proofing properties with ease. Also, even on members having a shape or size that makes it difficult to form stain-proofing thin films directly on the members, the sheet, having been cut out in any desired size and shape, may be stuck thereon to endow them with stain-proofing properties. Thus, the sheet can be disposed on the surfaces of articles having various sizes and shapes, including buildings, and any desired objects can freely be endowed with anti-fogging and stain-proofing properties.

The sheet of the present invention may also be so made as to be exchangeable with ease by selecting the manner of attachment appropriately. Thus, where its stain-proofing properties have lowered after it has been stuck on an article, it can be changed for a new sheet with ease. In the past, since stain-proofing films are directly formed on the surfaces of articles, it has been very difficult to restore stain-proofing properties even where the stain-proofing properties have lowered. However, according to the present invention, the sheet may only be changed for new one, whereby a surface again having superior stain-proofing properties can be obtained.

### The Preferred Embodiments

### EXAMPLE 1

A square white sheet glass of 2 mm thick and 5 cm long for each side is used as a substrate, and a functional film comprised of silicon oxide is formed on the substrate by RF sputtering, setting SiO₂ as a target. During the film formation, the vacuum chamber internal pressure is kept at 1.5 Pa, and 100 sccm of argon gas is fed into the chamber. RF power is set at 800 W, and film formation time, 1 hour.

In the present Example, the RMS value of unevenness of the outermost surface is controlled by adjusting the vacuum chamber internal pressure (a thin film having an unevenness with an RMS value of about 10 A can be formed when the vacuum chamber internal pressure is kept at about 0.5 Pa). Incidentally, the RMS value is also changeable by changing other conditions.

Layer thickness of the silicon oxide film formed under such conditions is measured with a stylus type layer thickness meter to find that it was 3,000 A.

The anti-fogging thin film thus formed has a contact angle of water of 5 degrees immediately after film formation. This contact angle is again measured after the film is left in a room for 2 months, to find that it is still 5 degrees. Thus, it is evident that superior hydrophilic properties are maintained for a long term. Also, the film surface is breathed on, whereupon the surface did not fog at all in both the cases of immediately after film formation and after leaving for 2 months.

This glass substrate with film is further put in a thermostatic chamber set at 5° C., for 1 hour and thereafter moved instantaneously into a thermo-hygrostat kept at 25° C./85% RH, whereupon a thin water film is formed on the surface, but the transparency of the glass is not damaged at all, thus a superior anti-fogging performance is confirmed.

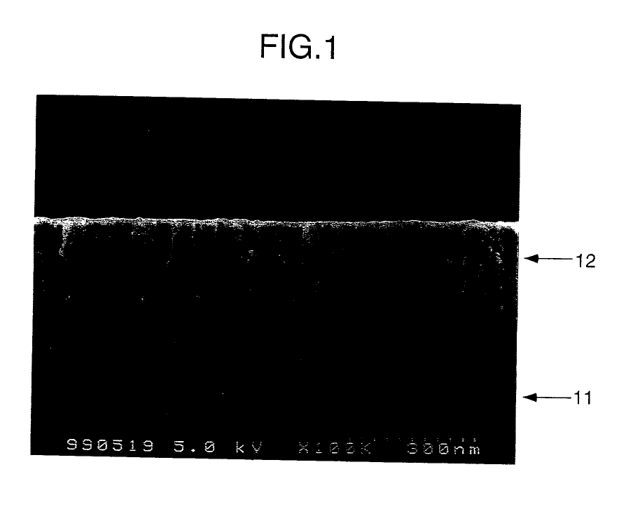

The surface roughness of the anti-fogging functional film of the present Example is measured with an AFM to reveal that the RMS value is 27 A, thus a fine unevenness is found to have been formed on the surface. An SEM photograph is shown in FIG. 1 as a cross section of an article comprising a silicon substrate 11 and formed thereon a functional film 12 having anti-fogging properties, obtained in the present Example.

As can be seen from this photograph, the functional film of the present Example has a columnar structure in its cross section, where microscopic dales (blind holes) are deeply present. Incidentally, in this photograph, a region of about 0.2 mm (in the case of a photograph with dimensions, length and width, of 8.3 cm×11.1 cm) in the thickness direction from the outermost surface corresponds to the depth with an RMS value of about 27 A.

### EXAMPLE 2

On the surface of an eye-glass lens substrate of 80 mm diameter, made of plastic, a silicon oxide film is formed by vacuum deposition. The film was formed by an electron beam heating deposition process in which, into a vacuum chamber kept to a degree of vacuum of 8×10⁻⁴ Pa, oxygen is fed to make a pressure of 6.7×10⁻³ Pa and SiO₂ granules are used as a deposition source. Here, setting the power of electron beams at about 90 mA, an SiO₂ film with a layer thickness of 1,500 A is formed.

Next, the film thus obtained is treated with oxygen plasma to form a fine unevenness at the surface. Oxygen flow rate is set at 100 sccm; RF power, 500 W; pressure, 26 Pa; and treatment time, 300 seconds.

The contact angle of water on the film surface is measured after the treatment with oxygen plasma, to find that it is 7 degrees. This contact angle is again measured after the film is left in a room for 2 months, to find that it is still 7 degrees. Thus, it is evident that superior hydrophilic properties are maintained. Also, the film surface is breathed on, whereupon the surface does not fog at all in both the cases of immediately after treatment with oxygen plasma and after leaving for 2 months.

This plastic lens substrate with film is further put in a thermostatic chamber set at 5° C., for 1 hour and thereafter moved instantaneously into a thermo-hygrostat kept at 25° C./85% RH, whereupon a thin water film is formed on the surface, but the transparency of the glass is not damaged at all, thus a superior anti-fogging performance is confirmed.

The surface roughness of the functional film of the present Example is measured with an AFM to reveal that the RMS value is 25 A, thus a fine unevenness is found to have been formed on the surface.

### COMPARATIVE EXAMPLE 1

The procedure of Example 2 is repeated except that the treatment with oxygen plasma is not made after the anti-fogging thin film is formed.

The contact angle of water is measured after the anti-fogging thin film is formed, to find that it is 8 degrees, but, when this is again measured after the film is left in a room for 2 months, it is found to have become as large as 40 degrees. Also, the film surface is breathed on, whereupon, although the surface did not fog immediately after film formation, the one having left for 2 months easily turns foggy in white with breath.

This plastic lens substrate with the SiO₂ film formed thereon is further put in a thermostatic chamber set at 5° C., for 1 hour and thereafter moved instantaneously into a thermo-hygrostat kept at 25° C./85% RH, whereupon a thin water film is formed on the surface, but the transparency of the glass is not damaged at all immediately after film formation, thus an anti-fogging performance is confirmed. However, the plastic substrate having been left for 2 months fogs instantaneously when it is moved into the thermo-hygrostat kept at 25° C./85% RH, thus the anti-fogging performance has been lost.

The surface roughness of the SiO₂ film of the present Comparative Example is measured with an AFM to reveal that the RMS value is 8 A, thus the surface is found to have a shallow unevenness and be flat, compared with the surfaces of the films of Examples 1 and 2.

### EXAMPLE 3

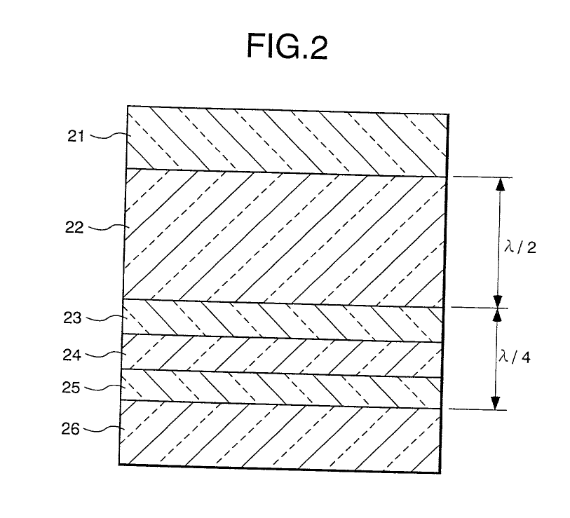

In the present Example, an optical article is produced, having a five-layer stacked film as shown in FIG. 2.

First, as a substrate 26, a soda-lime glass of 8 cm in diameter is prepared. After it is cleaned, a lowermost layer 25 comprised of silicon oxide, a second layer 24 comprised of zirconium oxide, a third layer 23 comprised of silicon oxide and a fourth layer 22 comprised of zirconium oxide are superposingly formed in this order by vacuum deposition. Taking account of the reflection preventive effect, the lowermost layer to the third layer are formed in an optical layer thickness of λ/4 in total, and the fourth layer is formed in an optical layer thickness of λ/2. Here, the center wavelength λ was 535 nm.

Thereafter, on this four-layer film, a functional film 21 composed chiefly of silicon oxide is formed by RF sputtering. Silicon oxide is used as a target, the internal pressure of a vacuum chamber is set at 2 Pa, and the substrate is not heated. As a sputtering gas, only argon gas containing no oxygen is fed into the vacuum chamber during film formation. RF power is set at 800 W, and film formation time, 35 minutes. The functional film thus obtained, comprised of silicon oxide, is in a layer thickness of 1,160 A, and substrate temperature during film formation was about 60° C.

In order to evaluate hydrophilic properties of the functional film thus formed, its contact angle to water at rest was measured. As the result, its contact angles immediately after film formation and the contact angle after lapse of 5 weeks are both about 3 degrees, and good hydrophilic properties are retained. Thus, the article having the functional film of the present invention is found to maintain its hydrophilic properties (i.e., anti-fogging properties and stain-proofing properties) over a long period of time.

This article has spectral reflection characteristics such that its reflectance in the wavelength region of 450 to 800 nm is lower than 3%. For example, in the case of lenses for cameras, their transmittance greatly decreases with an increase in the number of lenses combined, to cause a problem of loss of brightness. However, the article of the present Example may by no means make the transmittance poor because it has a reflectance of 3% or lower. Moreover, it can also prevent the transmittance from decreasing as a result of fogging or adhesion of contaminants, and hence can achieve a further improvement in transmittance.

### EXAMPLE 4

An optical article is produced under the same conditions as in Example 3 except that the internal pressure of the vacuum chamber for RF suttering is set at 3 Pa and the film formation time 50 minutes. The functional film comprised of silicon oxide, formed under such conditions, is in a layer thickness of about 920 A, and substrate temperature during film formation is about 65° C.

The hydrophilic properties of the functional film thus formed are evaluated in the same manner as in Example 1 to reveal that its contact angle immediately after film formation is about 3 degrees and the contact angle after lapse of 5 weeks is about 4 degrees, and good hydrophilic properties are retained. Thus, the article produced in the present Example is also ascertained to maintain anti-fogging properties and stain-proofing properties over a long period of time, like the case of Example 3. In the article of the present Example, too, its reflectance is 3% or lower. Hence, like Example 3, the problem on transmittance can be relieved.

### EXAMPLE 5

(1) Formation of Functional Film:

In the present Example, boro-silicate glass manufactured by Nippon Sheet Glass Co., Ltd. is used as a substrate. On the surface of this substrate, a functional film comprised of a silicon oxide was formed by RF sputtering, and an article having this film at the outermost surface is prepared. Here, an SiO₂ target is used as a sputtering target, and Ar gas as a sputtering gas. The pressure at the time of sputtering is set at 2 Pa; RF power, 800 W; and film formation time, 15 minutes. The functional film thus formed is in a layer thickness of 500 A.

(2) Observation of Functional Film by AFM and SEM:

The form of the functional film formed in the above (1) is observed with an AFM to reveal that the value of [average value of pitch of unevenness]/[RMS value of surface roughness of unevenness] is 0.8. Also, the surface of the functional film has an RMS value of 10 A. Still also, observation of film cross section by SEM (scanning electron microscopy) reveals that the functional film of the present Example has the columnar structure.

(3) Analysis by X-Ray Photoelectron Spectroscopy:

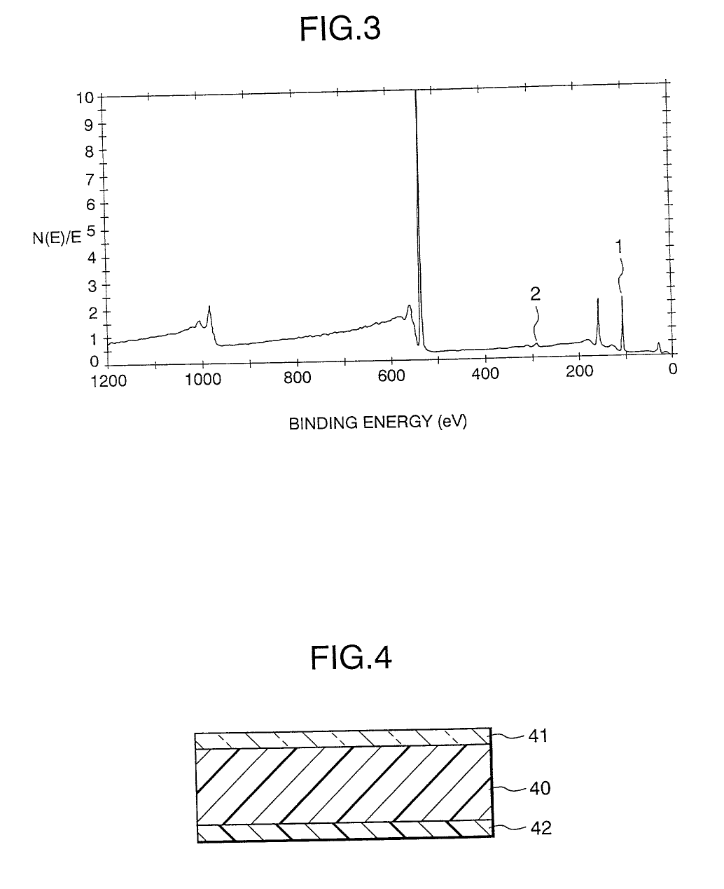

The functional film formed in the above (1) is analyzed by X-ray photoelectron spectroscopy upon lapse of a day after film formation. Its qualitative analysis is made by wide scan to obtain the results shown in FIG. 3. In FIG. 3, a peak of photoelectrons due to silicon is denoted as 1, and a peak of photoelectrons due to carbon constituting organic contaminants adhered to the surface, is denoted as 2. As can be seen also from this FIG. 3, the peak 2 of photoelectrons due to carbon is very small.

Portions of energy ranges of photoelectrons due to carbon and silicon are further narrow-scanned, and quantitative analysis is made from peak areas of their photoelectrons to determine the atomic ratio of carbon to silicon. As the result, the value of [number of carbon atoms]/[number of silicon atoms] is 0.1.

(4) Follow-Up of Changes with Time of Surface Staining:

Changes with time of surface staining of the functional film formed in the above (1) is followed up by the same method as in the above (2). As the result, even upon lapse of a month after film formation, the value of [number of carbon atoms]/[number of silicon atoms] is 0.1. This shows that the functional film of the present invention maintains over a long period of time the effect of preventing organic contaminants from adhering to the film surface.

### COMPARATIVE EXAMPLE 2

(1) Formation of Functional Film:

In the present Comparative Example, the same boro-silicate glass as used in Example 5 is used as a substrate. On the surface of this substrate, a film comprised of a silicon oxide is formed by vacuum deposition. Granular SiO₂ (granule diameter: 1 to 3 mm) is used as a deposition source. The vacuum deposition is carried out at a degree of vacuum of 2×10⁻⁵ Torr (2.66×10⁻³ Pa), and the film is formed for 2 minutes to obtain an oxide film with a layer thickness of 500 A.

(2) Observation of Oxide Film by AFM and SEM:

The form of the functional film formed in the above (1) is observed with an AFM to reveal that the value of [average value of pitch of unevenness]/[RMS value of surface roughness of unevenness] is 3. Also, the surface of the oxide film has an RMS value of 5 A. Still also, observation of film cross section by SEM does not reveal any particular characteristic structure (e.g., the columnar structure as in Example 5).

(3) Analysis by X-Ray Photoelectron Spectroscopy:

In the same manner as in Example 5, the oxide film formed in the above (1) is analyzed by X-ray photoelectron spectroscopy upon lapse of a day after film formation. Then, quantitative analysis is made to determine the atomic ratio of carbon to silicon. As the result, the value of [number of carbon atoms]/[number of silicon atoms] is 0.2.

(4) Follow-Up of Changes with Time of Surface Staining:

Changes with time of surface staining of the oxide film formed in the above (1) is followed up by the same method as in the above (2). As the result, the value of [number of carbon atoms]/[number of silicon atoms] upon lapse of a month after film formation is 0.4, showing a rapid increase in organic contaminants having adhered to the film surface, compared with results obtained upon lapse of a day after film formation.

### EXAMPLE 6 & COMPARATIVE EXAMPLE 3

In the present Example and Comparative Example, stain-proofing mirrors are produced.

A mirror manufactured by Nippon Sheet Glass Co., Ltd. is used as a substrate. On the surface of this substrate, a functional film comprised of a silicon oxide is formed in the same manner as in Example 5 to produce a stain-proofing mirror (Example 6). Also, on the surface of another like substrate, the same oxide film as that of Comparative Example 2 is formed to produce a comparative mirror (Comparative Example 3).

The two mirrors thus obtained are left for a month in a washroom of a home. As a result, spot-like stains are observable on the mirror of Comparative Example 3, whereas no stain is observable on the stain-proofing mirror of Example 3, showing a stain-proofing effect of the functional film of the present invention.

### EXAMPLE 7 & COMPARATIVE EXAMPLE 4

In the present Example and Comparative Example, stain-proofing lenses are produced.

A plastic (CR39) lens comprised of di-ethyleneglycol-bis-allylcarbonate is used as a substrate. On the surface of this substrate, a silicon oxide/zirconium oxide four-layer film is formed by vacuum deposition. More specifically, a lowermost layer of silicon oxide, a second layer of zirconium oxide, a third layer of silicon oxide and a fourth layer of zirconium oxide are superposingly formed in this order. Taking account of the reflection preventive effect, the lowermost layer to the third layer are formed in an optical layer thickness of λ/4 in total, and the fourth layer is formed in an optical layer thickness of λ/2. Here, the center wavelength λ is 535 nm.

Thereafter, on this four-layer film, a functional film comprised of a silicon oxide is formed in the same manner as in Example 5 to produce a stain-proofing lens (Example 7). Also, on a like substrate on which a four-layer film is formed in the same manner as the above, an oxide film is formed in the same manner as in Comparative Example 2 to produce a comparative lens (Comparative Example 4).

Oleic acid is coated on the surfaces of these two lenses, and the lenses obtained are immersed in water, keeping them horizontally. As the result, in the lens of Comparative Example 4 the oleic acid remaines adhering to the lens surface, whereas in the stain-proofing lens of Example 7 the oleic acid come apart from the lens surface to have come to the water surface.

Spectral reflection characteristics (reflectance) of the stain-proofing lens of Example 7 is measured to obtain the result that its reflectance to light in the wavelength region of 450 to 800 nm is lower than 3%, showing that the coating layer (i.e., a coating layer consisting of the silicon oxide/zirconium oxide four-layer film and formed thereon the functional film of Example 7, five layers in total) formed on the lens has a reflection preventive effect.

Thus, the functional film of Example 7 is found to be a film from which any stains having adhered to the surface are removable with ease compared with conventional films. It is also shown that the functional film of Example 7 is applicable also as a coating layer having a reflection preventive effect.

### EXAMPLE 8

(1) Formation of Functional Film:

A stain-proofing article as shown in FIG. 4 is produced, using a polycarbonate sheet of 0.5 mm thick as a substrate 40. On the surface of this substrate, a functional film 41 comprised of a silicon oxide is formed by RF sputtering, and, on the back thereof, a double-side pressure-sensitive tape 42 is stuck.

Here, an SiO₂ target is used as a sputtering target, and Ar gas as a sputtering gas. The pressure at the time of sputtering is set at 2 Pa; RF power, 800 W; and film formation time, 30 minutes. The functional film thus formed is in a layer thickness of 1,000 A.

Thus, a stain-proofing plastic sheet is obtained, having on its surface a functional film having stain-proofing properties.

(2) Evaluation of Stain-Proofing Performance:

Two white tiles for outer walls are prepared, on one of which the stain-proofing plastic sheet is stuck and on the other of which nothing is stuck to stand as it is. Then, these two tiles are left for a month at a place exposed to wind and rain.

After a month, how the surface stained is observed, where the tile to which the stain-proofing plastic sheet was stuck stood only stained in very pale gray, but the tile to which nothing was stuck stood stained in black, also clearly leaving marks of raindrops flowed.

These two tiles are further watered to attempt to remove stains, where the stains having adhered to the tile on which the stain-proofing plastic sheet is stuck is washed off with ease, but the stains on the tile on which nothing is stuck are not completely removable even though rubbed strongly.

(3) Observation of Functional Film by AFM and SEM:

The form of the functional film formed in the above (1) is observed with an AFM. The RMS value of the film surface is determined from the AFM observation to find that it is 10 A. Also, observation of film cross section by SEM reveales that the film has the columnar structure.

### EXAMPLE 9

(1) Formation of Functional Film:

A commercially available cellophane tape is used as a substrate. On the surface of this substrate, a functional film comprised of a silicon oxide is formed by RF sputtering. Here, an SiO₂ target is used as a sputtering target, and Ar gas as a sputtering gas. To form the film, the pressure at the time of sputtering is set at 2 Pa; RF power, 800 W; and film formation time, 15 minutes. The functional film thus formed is in a layer thickness of 500 A.

Thus, a plastic film is obtained, having on the cellophane tape a functional film having stain-proofing properties.

(2) Evaluation of Stain-Proofing Performance:

On a cathode ray tube of a television installed in a room, the stain-proofing plastic film and a cellophane tape on which no film is formed are each stuck, and the television is put to use for a month. After a moth, how both the tape surfaces stained is observed, where the part on which the stain-proofing plastic film is stuck does not particularly seem to have stained, but on the other hand the part on which the usual tape is stuck and the part on which nothing is stuck stood stained darkly.

(3) Analysis by X-Ray Photoelectron Spectroscopy:

The surface of the functional film of the stain-proofing plastic film produced in the above (1) is analyzed by X-ray photoelectron spectroscopy upon lapse of a day after film formation. Portions of energy ranges of photoelectrons due to carbon and silicon are narrow-scanned, and quantitative analysis is made from peak areas of their photoelectrons to determine the atomic ratio of carbon to silicon. As the result, the value of [number of carbon atoms]/[number of silicon atoms] is 0.1.

The sheet obtained in the above (1) is further stuck on the surface of the cathode ray tube, and the same measurement as the above is made after lapse of a month to find that the value of [number of carbon atoms]/[number of silicon atoms] is 0.1, showing that the stain-proofing effect of preventing organic contaminants from adhering to the film surface is maintained over a long period of time.

We claim:

1. A functional film at least one surface of which has at least one of the following characteristics (1) to (3).
(1) The surface has an unevenness that a surface roughness of said surface is from 10 A to 500 A as RMS value;
(2) the surface has an unevenness whose pitch has an average value not larger than the RMS value of surface roughness; and
(3) the surface comprises an oxide of an inorganic element, represented by M, and the value of (number of carbon atoms)/(number of M atoms) at the surface is 0.1 or less.

2. The functional film according to claim 1, which is at least one of an anti-fogging film, a stain-proofing film and a reflection preventive film.

3. The functional film according to claim 1, wherein the pitch of said unevenness has an average value of from 1 A to 1,000 A.

4. The functional film according to claim 1, which has a thickness of 200 A or larger.

5. The functional film according to claim 1, which has hydroxyl groups at the surface.

6. The functional film according to claim 1, which has a reflectance of 3% or smaller to light with a wavelength of 450 nm to 800 nm.

7. The functional film according to claim 1, which has a fine columnar structure.

8. The functional film according to claim 1, which comprises at least one of an inorganic oxide and an organic macromolecule.

9. The functional film according to claim 8, which comprises a silicon oxide.

10. The functional film according to claim 8, which comprises hydrophilic particles.

11. Use of the functional film according to claim 1, which prevents at least one of fogging caused by water droplets and adhesion of contaminants.

12. An article having on its surface the functional film according to claim 1.

13. The article according to claim 12, which is an optical article.

14. The article according to claim 12, which comprises a sheetlike substrate and said functional film; the latter being provided on one-side surface of the both sides of the former.

15. The article according to claim 14, which has an adhesive film on the other-side surface of said sheetlike substrate.

16. The article according to claim 14, wherein said functional film comprises a silicon oxide.

17. A sheet comprising a substrate comprised of an organic macromolecule, and a film having stain-proofing properties, provided on the surface of said substrate.

18. The sheet according to claim 17, wherein said film comprises a silicon oxide.

19. A process for producing a functional film, comprising forming by a dry process the functional film according to claim 1.

20. The production process according to claim 19, wherein said dry process is sputtering.

21. A process for producing a functional film, comprising forming into a film a macromolecule composition or macromolecule precursor composition containing hydrophilic particles, followed by curing.

22. A process for producing the functional film according to claim 1, the process comprising the steps of;
forming into a film a macromolecule composition or macromolecule precursor composition containing hydrophilic particles;
removing the particles; and
curing the film of the macromolecule composition or macromolecule precursor.

23. A process for producing the article according to claim 12, the process comprising a film-forming step of forming the functional film on the surface of a substrate by a dry process.

24. A process for producing an article having on its surface the functional film, comprising a film-forming step of forming by sputtering a film having stain-proofing properties, on a substrate;
said film-forming step comprising the steps of;
placing said substrate in a vacuum chamber and placing a target composed chiefly of an inorganic oxide, at a position facing said substrate;
setting the internal pressure of the vacuum chamber to from 1 Pa to 10 Pa;
feeding a sputtering gas into the vacuum chamber; and
applying a voltage to the target.

25. The production process according to claim 24, wherein said substrate in the step of applying a voltage to the target is set at a temperature of from 30° C. to 150° C.

26. The production process according to claim 24, wherein said sputtering gas is an inert gas containing no oxygen.
